(19) United States
(12) Patent Application Publication
(10) Pub. No.: US 2024/0344888 A1
(43) Pub. Date: Oct. 17, 2024

(54) ESTIMATION SYSTEM, HUMAN MONITORING SYSTEM, ESTIMATION METHOD, AND PROGRAM

(71) Applicant: Panasonic Intellectual Property Management Co., Ltd., Osaka (JP)

(72) Inventors: Ryota SUDO, Aichi (JP); Nobuaki SHIMAMOTO, Fukui (JP); Yuichi YAMAMOTO, Kyoto (JP); Takashi HARADA, Hyogo (JP); Yasushi SAKASHITA, Osaka (JP)

(21) Appl. No.: 18/263,836

(22) PCT Filed: Dec. 28, 2021
(86) PCT No.: PCT/JP2021/048945

§ 371 Date: Jan. 8, 2024

(30) Foreign Application Priority Data
Feb. 9, 2021 (JP) 2021-019357

(51) Int. Cl. G01J 5/00; G06T 7/70; G06V 20/52; G06V 40/10

(52) U.S. Cl. CPC G01J 5/0025; G06T 7/70; G06V 20/53; G06V 40/103; G01J 2005/0077; G06T 2207/10048; G06T 2207/30196

(57) ABSTRACT

An aspect of the present disclosure is to accurately estimate whether or not a plurality of people are in close contact with each other in a target space. An estimation system (1) includes a first estimator (12) and a second estimator (13). The first estimator (12) is configured to estimate, based on a heat distribution including a plurality of heat sources detected by at least one infrared sensor (2), three-dimensional positions of heads of a plurality of people in a target space. The second estimator (13) is configured to estimate, based on data on the three-dimensional positions estimated by the first estimator (12), estimate whether or not the plurality of people are in close contact with each other.

### TECHNICAL FIELD

The present disclosure generally relates to estimation systems, human monitoring systems, estimation methods, and programs and specifically relates to an estimation system, a human monitoring system, an estimation method, and a program for estimating a state of a plurality of people in a target space.

### BACKGROUND ART

Patent Literature 1 describes a human occupancy detection system (estimation system) configured to detect humans in a space (target space) in a train, a building, or the like to determine the degree of crowdedness in the space. The human occupancy detection system described in Patent Literature 1 defines a ratio of a human presence region to a detection region of an infrared sensor as the degree of crowdedness in the space.

The human occupancy detection system described in Patent Literature 1 makes a determination based on the target space considered as a two-dimensional plane and can thus not accurately estimate (determine) whether or not a plurality of people are in close contact with each other in the space.

### CITATION LIST

### Patent Literature

Patent Literature 1: JP H08-161292 A

### SUMMARY OF INVENTION

It is an object of the present disclosure to provide an estimation system, a human monitoring system, an estimation method, and a program which are configured to accurately estimate whether or not a plurality of people are in close contact with each other in a target space.

An estimation system according to an aspect of the present disclosure includes a first estimator and a second estimator. The first estimator is configured to estimate, based on a heat distribution including a plurality of heat sources detected by at least one infrared sensor, three-dimensional positions of heads of a plurality of people in a target space. The second estimator is configured to estimate, based on data on the three-dimensional positions estimated by the first estimator, whether or not the plurality of people are in close contact with each other.

A human monitoring system according to an aspect of the present disclosure includes the estimation system and the infrared sensor.

An estimation method according to an aspect of the present disclosure includes a first estimation step and a second estimation step. The first estimation step is a step of estimating, based on a heat distribution including a plurality of heat sources detected by an infrared sensor, three-dimensional positions of heads of a plurality of people in a target space. The second estimation step is a step of estimating, based on data on the three-dimensional positions estimated in the first estimation step, whether or not the plurality of people are in close contact with each other.

A program according to an aspect of the present disclosure is a program configured to cause one or more processors to execute the estimation method.

### BRIEF DESCRIPTION OF DRAWINGS

FIG. 1 is a block diagram of a configuration of an estimation system and a human monitoring system according to an embodiment;

FIG. 2 is a simplified schematic view of an application example of the human monitoring system;

FIG. 3 is a flowchart of an operation example of the human monitoring system; and

FIG. 4 is a graph of a change in a contamination degree when an estimation system according to a first variation of the embodiment estimates a contamination degree of air in the target space.

### DESCRIPTION OF EMBODIMENTS

### Embodiment

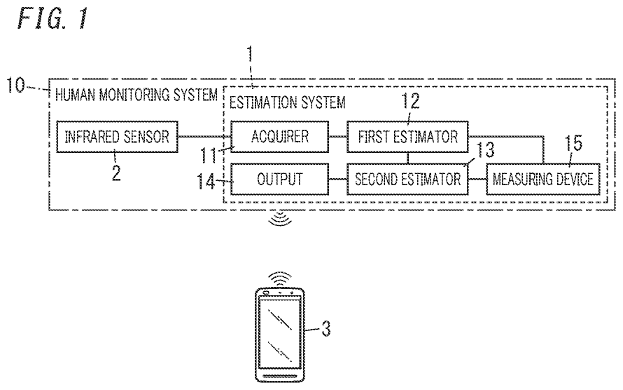

An estimation system 1 and a human monitoring system 10 according to an embodiment will be described below with reference to FIGS. 1 to 4.

### (1) Overview

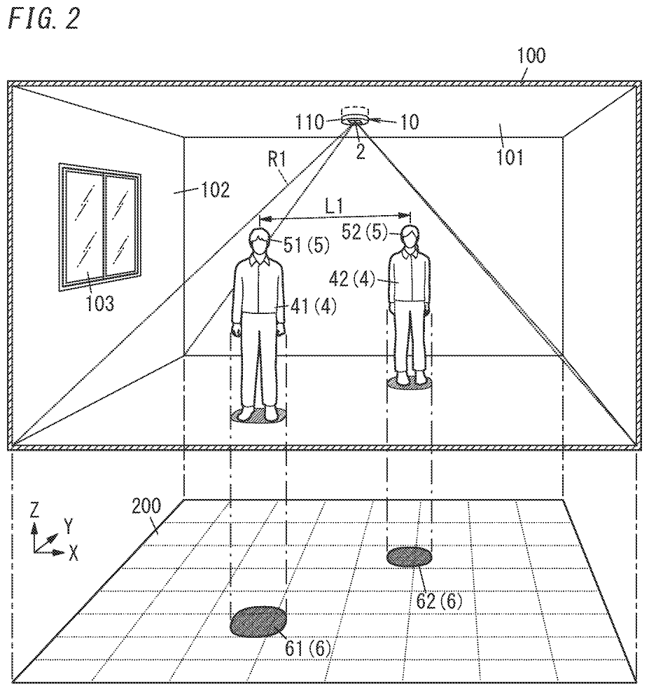

First of all, an overview of the estimation system 1 and the human monitoring system 10 according to the embodiment will be described with reference to FIGS. 1 and 2.

As shown in FIG. 2, the human monitoring system 10 according to the embodiment is a system for monitoring a plurality of (in the example shown in the figure, two) people 4 present in a target space 100 by using an infrared sensor 2. The target space 100 is, for example, an internal space of a building. Examples of the building include a dwelling house such as a detached dwelling house or each dwelling unit of a multifamily residential building (e.g., condominium) and a non-dwelling facility such as a hospital, a school, a retail establishment, and an office building. As shown in FIG. 1, the human monitoring system 10 includes the estimation system 1 and the infrared sensor 2. In the present embodiment, the human monitoring system 10 includes one infrared sensor 2.

The estimation system 1 is a system for estimating, based on a detection result by the infrared sensor 2, whether or not the plurality of people 4 present in the target space 100 are in close contact with each other. As shown in FIG. 1, the estimation system 1 includes a first estimator 12 and a second estimator 13. Moreover, the estimation system 1 further includes an acquirer 11, an output 14, and a measuring device 15. The first estimator 12 estimates, based on a thermal image (heat distribution) 200 (see FIG. 2) including a plurality of heat sources 6 (see FIG. 2) detected by the infrared sensor 2, three-dimensional positions of heads 5 (see FIG. 2) of the plurality of people 4 in the target space 100. The second estimator 13 estimates, based on data on the three-dimensional positions of the heads 5 of the plurality of people 4 estimated by the first estimator 12, whether or not the plurality of people 4 are in close contact with each other.

The acquirer 11 acquires the thermal image 200, which is the detection result by the infrared sensor 2. The output 14 outputs an estimation result by the second estimator 13. The measuring device 15 measures a residence time which is an amount of time each of the plurality of heat sources 6 spends in the target space 100.

In the estimation system 1 and the human monitoring system 10 according to the embodiment, the first estimator 12 estimates, based on the thermal image (heat distribution) 200 including the plurality of heat sources 6, the three-dimensional positions of the heads 5 of the plurality of people 4 as described above. Therefore, the second estimator 13 can calculate a distance between the heads 5 of the plurality of people 4 from the data on the three-dimensional positions of the heads 5 of the plurality of people 4 and can estimate whether or not the plurality of people 4 are in close contact with each other by comparing the distance with a reference value (threshold). That is, the estimation system 1 and the human monitoring system 10 of the embodiment can accurately estimate whether or not the plurality of people 4 are in close contact with each other in the target space 100.

### (2) Details

Next, the configuration of the estimation system 1 and the human monitoring system 10 according to the embodiment will be described with reference to FIGS. 1 and 2. As described above, the human monitoring system 10 includes the estimation system 1 and the infrared sensor 2. In the present embodiment, the human monitoring system 10 includes one infrared sensor 2.

### (2.1) Infrared Sensor

The infrared sensor 2 is, for example, a passive sensor. The infrared sensor 2 detects an object by receiving an infrared ray output from the object. Examples of the object include the plurality of people 4 present in the target space 100. In the present embodiment, The infrared sensor 2 detects the plurality of people 4 by receiving infrared rays output from the plurality of people 4.

The infrared sensor 2 generates the thermal image (heat distribution) 200 including, for example, the plurality of heat sources 6. The thermal image 200 is, for example, an 8×8-pixel (64-pixel) image. The plurality of heat sources 6 correspond to the plurality of people 4 on a one-to-one basis. Moreover, the thermal image 200 includes temperature information on the objects. In the thermal image 200, for example, the pixels have different densities depending on the temperature of the objects. For example, in the thermal image 200, the density of a pixel corresponding to a high temperature is high, whereas the density of a pixel corresponding to a low temperature is low. Thus, based on the thermal image 200 output from the infrared sensor 2, temperatures (body temperatures) of the objects can also be detected.

Here, the size (area) of each heat source 6 depends on the distance to the infrared sensor 2. More specifically, as the distance from the heat source 6 to the infrared sensor 2 decreases, the size of the heat source 6 increases. For example, in the example shown in FIG. 2, of the plurality of (two) people 4, a person 41 on the left is closer to the infrared sensor 2 than a person 42 on the right is, and therefore, the size of a heat source 61 corresponding to the person 41 is larger than the size of a heat source 62 corresponding to the person 42.

In the present embodiment, the infrared sensor 2 is disposed on a ceiling 101 facing the target space 100 as shown in FIG. 2. The target space 100 is, as described above, the internal space (hereinafter also referred to as an “internal space 100”) of the building. That is, in the present embodiment, the infrared sensor 2 is disposed on the ceiling 101 facing the internal space 100 of the building. More specifically, the infrared sensor 2 is disposed substantially at the center of the ceiling 101 so that the entire floor surface of the target space 100 is a detection region RI (see FIG. 2) of the infrared sensor 2. In the present embodiment, the infrared sensor 2 is, together with the estimation system 1, housed in a housing 110 (see FIG. 2). That is, in the present embodiment, the infrared sensor 2 and the estimation system 1 are configured integrally with each other as one piece.

### (2.2) Estimation System

The estimation system 1 according to the embodiment can be implemented by, for example, a computer system including one or more processors and one or more memory elements. That is, the one or more processors execute a program(s) stored in the one or more memory elements of the computer system, thereby functioning as the estimation system 1 according to the embodiment. The program(s) may be stored in the memory element(s) in advance, may be provided over a telecommunications network such as the Internet, or may be provided as a non-transitory recording medium such as a memory card storing the program.

As shown in FIG. 1, the estimation system 1 according to the embodiment includes the first estimator 12 and the second estimator 13. Moreover, the estimation system 1 according to the embodiment further includes the acquirer 11, the output 14, and the measuring device 15.

The acquirer 11 acquires the thermal image 200 from the infrared sensor 2 at a constant interval (e.g., 0.1 seconds). The acquirer 11 sequentially outputs the thermal image 200 acquired from the infrared sensor 2 to the first estimator 12.

The first estimator 12 estimates, based on the thermal image 200 acquired from the acquirer 11, the three-dimensional positions of the objects. As described above, the objects are the plurality of people 4 present in the target space 100. That is, the first estimator 12 estimates, based on the thermal image (heat distribution) 200 including the plurality of heat sources 6 detected by the infrared sensor 2, the three-dimensional positions of the heads 5 of the plurality of people 4 in the target space 100. Moreover, as described above, the plurality of people 4 correspond to the plurality of heat sources 6 on a one-to-one basis, and as the size (area) of each heat source 6 in the thermal image 200 increases, the height (body height) of a corresponding one of the people 4 also increases. Therefore, the first estimator 12 can estimate, from the size of each heat source 6, the height to the head 5 of the corresponding one of the people 4. More specifically, the first estimator 12 has a database in which the relationship between the size of each heat source 6 and the height to the head 5 of a corresponding one of the people 4 is defined, and based on the database, the first estimator 12 estimates, from the size of each heat source 6, the height to the head 5 of the corresponding one of the people 4. Moreover, in the database, the relationship between the location of each heat source 6 in the thermal image 200 and the location of a corresponding one of the people 4 present in the target space 100 is also defined. Thus, the first estimator 12 can acquire location data in an X-axis direction, location data in a Y-axis direction, and location data in the Z-axis direction as pieces of data on the three-dimensional position of each person 4. The first estimator 12 outputs the data on the three-dimensional positions of the heads 5 of the plurality of people 4 to the second estimator 13.

The second estimator 13 estimates, based on the data on the three-dimensional positions estimated by the first estimator 12, whether or not the plurality of people 4 present in the target space 100 are in close contact with each other. More specifically, the second estimator 13 calculates the distance between the heads 5 of the plurality of people 4 from the data on the three-dimensional positions of the plurality of people 4. For example, in the example shown in FIG. 2, data on the three-dimensional position of the head 51 of the person 41 on the left is defined as (X1, Y1, Z1), and data on the three-dimensional position of the head 52 of the person 42 on the right is defined as (X2, Y2, Z2). In this case, a distance L1 between the head 51 of the person 41 and the head 52 of the person 42 is obtained by a formula (1).

$$\begin{matrix}[ Formula 1 ] & \\ L 1 = \sqrt{{( X 2 - X 1 )}^{2} + {( Y 2 - Y 1 )}^{2} + {( Z 2 - Z 1 )}^{2}} & ( 1 )\end{matrix}$$

Then, the second estimator 13 compares the distance L1 calculated by the formula (1) with a reference value (threshold) set in advance, thereby estimating whether or not the person 41 and the person 42 are in close contact with each other. More specifically, when the distance L1 is greater than or equal to the reference value, the second estimator 13 estimates that the person 41 and the person 42 are not in close contact with each other, and when the distance L1 is less than the reference value, the second estimator 13 estimates that the person 41 and the person 42 are in close contact with each other. In the present disclosure, “people are in close contact with each other” means not only the case where people are tightly in contact with each other without a gap therebetween but also the case where a distance in which a person can touch the body of another person is less than or equal to a predetermined distance (e.g., 1 m). The predetermined distance is, for example, a distance less than each of body heights of the people 4 and is stored in a storage in advance. Thus, a reference value with which the distance L1 is to be compared is set to, for example, 1 m.

The output 14 outputs the estimation result by the second estimator 13. The output 14 includes, for example, a communication interface. More specifically, the output 14 includes a communication interface capable of communicating with an external apparatus 3. The external apparatus 3 is, for example, a smartphone of each of the plurality of people 4. The output 14 outputs the estimation result by the second estimator 13 to the external apparatus 3. Specifically, when the person 41 and the person 42 are in close contact with each other, the output 14 outputs (transmits) a notice that the person 41 and the person 42 are in close contact with each other to the two external apparatuses 3 of the person 41 and the person 42. Thus, it becomes possible to prompt the person 41 and the person 42 not to be in close contact with each other.

The measuring device 15 measures a residence time of each of the plurality of people 4 in the target space 100. The measuring device 15 includes a timer. For example, the measuring device 15 starts measuring (counting) the residence time in response to reception of a measurement start instruction from the first estimator 12 and ends measuring the residence time in response to reception of a measurement end instruction from the first estimator 12. The measuring device 15 outputs a measurement result (the residence time of each heat source 6) to the second estimator 13.

Here, to estimate whether or not the plurality of people 4 present in the target space 100 are in close contact with each other, the second estimator 13 preferably not only compare the distance L1 between the heads 5 with the reference value but also takes the residence time of each of the plurality of people 4 in the target space 100 into consideration. More specifically, for example, even in the case of the distance L1 between the heads 5 being less than the reference value, the second estimator 13 may estimate that the plurality of people 4 are not in close contact with each other when at least one of a plurality of residence times of the respective plurality of people 4 is shorter than the predetermined time. Moreover, for example, even in the case of the distance L1 between the heads 5 being greater than or equal to the reference value, the second estimator 13 may estimate that the plurality of people 4 are in close contact with each other when each of all the residence times of the respective plurality of people 4 is longer than or equal to the predetermined time. That is, when at least one of the residence times of the plurality of heat sources 6 in the target space 100 is shorter than the predetermined time, the second estimator 13 may estimate that the plurality of people 4 are not in close contact with each other, and when the residence times are each longer than or equal to the predetermined time, the second estimator 13 may estimate, based on data on the three-dimensional positions, that the plurality of people 4 are in close contact with each other. This can improve an estimation accuracy as compared with the case where whether or not the plurality of people 4 are in close contact with each other by only comparing the distance L1 between the heads 5 with the reference value. In this case, the second estimator 13 not only determines whether or not the distance L1 between the heads 5 is greater than or equal to the reference value but also determines whether or not the residence time is longer than or equal to the predetermined time. Here, the predetermined time (threshold time) is, as an example, 3 to 4 minutes. Note that the predetermined time is not limited to the time described above. The predetermined time may be longer than, or shorter than, the time described above.

### (3) Operation

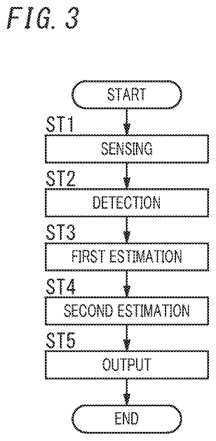

Next, an operation example of the human monitoring system 10 (estimation system 1) according to the embodiment will be described with reference to FIG. 3.

First, the human monitoring system 10 performs sensing in the target space 100 by using the infrared sensor 2 (step ST1). When objects are present in the target space 100, the infrared sensor 2 detects the objects (step ST2). In the example shown in FIG. 2, the infrared sensor 2 detects the plurality of people 4 as the objects.

The first estimator 12 of the estimation system 1 estimates, based on the thermal image 200 acquired from the infrared sensor 2 via the acquirer 11, the three-dimensional positions of the heads 5 of the plurality of people 4 (first estimation step ST3). The second estimator 13 of the estimation system 1 estimates, based on the data on the three-dimensional positions of the heads 5 of the plurality of people 4 which is an estimation result by the first estimator 12, whether or not the plurality of people 4 are in close contact with each other (second estimation step ST4).

Then, the output 14 of the estimation system 1 outputs (transmits) the estimation result by the second estimator 13 to the plurality of external apparatuses 3 of the respective plurality of people 4 (step ST5). This can notify the plurality of people 4 of that the plurality of people 4 are in close contact with each other.

### (4) Effects

In the estimation system 1 according to the embodiment, as described above, the first estimator 12 can estimate, based on the heat distribution (thermal image) 200 including the plurality of heat sources 6, the three-dimensional positions of the heads 5 of the plurality of people 4. Then, the second estimator 13 can calculate the distance between the heads 5 of the plurality of people 4 from the data on the three-dimensional positions of the heads 5 of the plurality of people 4 and can estimate whether or not the plurality of people 4 are in close contact with each other by comparing the distance with the reference value (threshold). That is, the estimation system 1 of the embodiment can accurately estimate whether or not the plurality of people 4 are in close contact with each other in the target space 100.

Moreover, the estimation system 1 according to the embodiment further includes the output 14 as described above. Thus, the estimation result by the second estimator 13 can be output (transmitted) to an outside (to the external apparatuses 3).

Moreover, the estimation system 1 according to embodiment, as described above, estimates, based on the residence times of the plurality of heat sources 6 (people 4) in the target space 100, whether or not the plurality of people 4 are in close contact with each other. Thus, as compared with the case where the residence times are not taken into consideration, the estimation accuracy when whether or not the plurality of people 4 are in close contact with each other is estimated can be improved.

### (5) Variations

The embodiment described above is a mere example of various embodiments of the present disclosure. The embodiment described above may be readily modified in various manners depending on a design choice or any other factor without departing from the scope of the present disclosure. Moreover, a similar function to the estimation system 1 may be implemented by an estimation method, a (computer) program, a non-transitory recording medium storing the program, or the like.

An estimation method according to an aspect includes a first estimation step ST3 and a second estimation step ST4. The first estimation step ST3 is a step of estimating, based on the heat distribution (thermal image) 200 including the plurality of heat sources 6 detected by the infrared sensor 2, the three-dimensional positions of the heads 5 of the plurality of people 4 in the target space 100. The second estimation step ST4 is a step of estimating, based on the data on the three-dimensional position estimated in the first estimation step ST3, whether or not the plurality of people 4 are in close contact with each other. Moreover, a program according to an aspect is a program configured to cause one or more processors to execute the estimation method described above.

Variations of the embodiment described above will be enumerated below. Any of the variations to be described below may be combined as appropriate.

### (5.1) First Variation

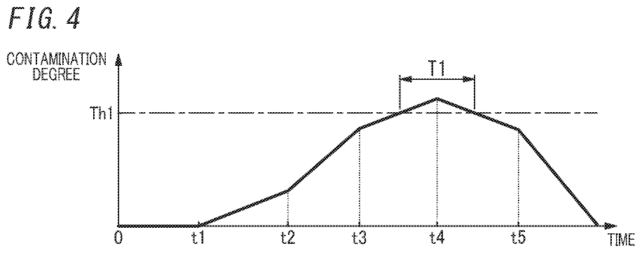

An estimation system 1 according to a first variation will be described with reference to FIG. 4.

The estimation system 1 according to the first variation is different from the estimation system 1 according to the embodiment described above in that the second estimator 13 further estimates the contamination degree of air in the target space 100. Note that the other configurations are similar to those in the estimation system 1 according to the embodiment described above, the same components are denoted by the same reference signs as those in the embodiment, and the description thereof is omitted.

In the estimation system 1 according to the first variation, as described above, the second estimator 13 is configured to estimate the contamination degree of air in the target space 100. Here, FIG. 4 shows an example in which each time the number of people 4 in the target space 100 increases by one, a count value representing the contamination degree of air in the target space 100 increases by “2” per minutes, and the count value in an air purifier disposed in the target space 100 decreases by “3” per minute. Note that the number of people 4 present in the target space 100 is detectable by the first estimator 12 on the bases of the thermal image 200 from the infrared sensor 2.

In a first period from a time point 0 to a time point t1, the number of the people 4 present in the target space 100 is 0 or 1, and the decrement (“−3”) of the count value by the air purifier is greater than the increment (“0” or “+2”) of the count value based on the person 4. Therefore, in the first period, the count value representing the contamination degree of air in the target space 100 remains “0”.

In a second period from the time point t1 to a time point t2, two people 4 are present in the target space 100, and the decrement (“−3”) of the count value by the air purifier is smaller than the increment (“+4”) of the count value based on the people 4. Therefore, in the second period, the count value representing the contamination degree of air in the target space 100 increases by “1” per minute.

In a third period from the time point 12 to a time point t3, three people 4 are present in the target space 100, and the decrement (“−3”) of the count value by the air purifier is smaller than the increment (“+6”) of the count value based on the people 4. Thus, in the third period, the count value representing the contamination degree of air in the target space 100 increases by “3” per minute.

In a fourth period from the time point 13 to a time point t4, two people 4 are present in the target space 100, and in a similar manner to the second time period, the count value representing the contamination degree of air in the target space 100 increases by “1” per minute.

In a fifth period from the time point 14 to a time point t5, one person 4 is present in the target space 100, and therefore, the decrement (“−3”) of the count value by the air purifier is greater than the increment (“+2”) of the count value based on the person 4. Thus, in the fifth period, the count value representing the contamination degree of air in the target space 100 decreases by “1” per minute.

Here, in a notification period T1 extending over both the fourth period and the fifth period, the count value representing the contamination degree of air in the target space 100 exceeds a threshold Th1, and thus the air in the target space 100 is contaminated. Therefore, in the notification period T1, a notice that the air in the target space 100 is contaminated is preferably output from the output 14. This can notify the people 4 present in the target space 100 of that the air in the target space 100 is contaminated.

In a sixth period after the time point t5, no person 4 is present in the target space 100, and therefore, the decrement (“−3”) of the count value by the air purifier is larger than the increment (“0”) of the count value based on the person 4. Thus, in the sixth period, the count value representing the contamination degree of air in the target space 100 decreases by “3” per minute toward “0)”.

The estimation system 1 according to the first variation can estimate not only whether or not the plurality of people 4 are in close contact with each other in the target space 100 but also the contamination degree of air in the target space 100.

### (5.2) Second Variation

An estimation system 1 according to a second variation will be described with reference to FIG. 2.

The estimation system 1 according to the second variation is different from the estimation system 1 according to the embodiment described above in that the first estimator 12 further estimates, based on trajectories of movements of the plurality of heat sources 6, moving directions of the plurality of people 4. Moreover, the estimation system 1 according to the second variation is different from the estimation system 1 according to the embodiment described above in that the second estimator 13 further estimates orientations of the heads 5 of the plurality of people 4 from the moving directions of the plurality of people 4 estimated by the first estimator 12, and based on the estimation result, the second estimator 13 estimates whether or not the plurality of people 4 are in close contact with each other. Note that the other configurations are similar to those in the estimation system 1 according to the embodiment described above, the same components are denoted by the same reference signs as those in the embodiment, and the description thereof is omitted.

In the estimation system 1 according to the second variation, the first estimator 12 estimates, based on the trajectories of movements of the plurality of heat sources 6, the moving directions of the plurality of people 4 in addition to the three-dimensional positions. The first estimator 12 acquires the thermal image 200 at the constant interval as described above, and therefore, based on the plurality of thermal images 200, the trajectories of movements of the plurality of heat sources 6 can be detected. Further, as described above, the plurality of heat sources 6 correspond to the plurality of people 4 on a one-to-one basis, and therefore, the first estimator 12 can estimate the moving directions of the plurality of people 4 from the trajectories of movements of the plurality of heat sources 6.

The second estimator 13 estimates the orientations of the heads 5 of the plurality of people 4 from the moving directions of the plurality of people 4 which are the estimation result by the first estimator 12. More specifically, the second estimator 13 estimates the orientations of the heads 5 of the plurality of people 4 provided that the plurality of people 4 are oriented and move in the moving direction. Moreover, the second estimator 13 estimates, based on the data on the three-dimensional positions and the orientations of the heads 5 of the plurality of people 4, whether or not the plurality of people 4 are in close contact with each other. More specifically, for example, in the example shown in FIG. 2, even in the case of the distance L1 between the head 51 of the person 41 on the left and the head 52 of the person 42 on the right being greater than or equal to the reference value, the second estimator 13 may estimate that the person 41 and the person 42 are in close contact with each other when the head 51 of the person 41 and the head 52 of the person 42 face each other. Moreover, even in the case of the distance L1 between the head 51 of the person 41 and the head 52 of the person 42 being less than the reference value, the second estimator 13 may estimate that the person 41 and the person 42 are not in close contact with each other when the head 51 of the person 41 and the head 52 of the person 42 are oriented in different directions.

The estimation system 1 according to the second variation has an improved estimation accuracy of estimation as to whether or not the plurality of people 4 are in close contact with each other as compared to the case where the orientations of the heads 5 of the plurality of people 4 are not taken into consideration.

### (5.3) Third Variation

An estimation system 1 according to a third variation will be described.

The estimation system 1 according to the third variation is different from the estimation system 1 according to the embodiment described above in that the first estimator 12 further estimates, based on the thermal image 200 including the plurality of heat sources 6, body temperatures of the plurality of people 4. Moreover, the estimation system 1 according to the third variation is different from the estimation system 1 according to the embodiment described above in that the second estimator 13 estimates, further based on the body temperatures of the plurality of people 4 estimated in the first estimator 12, whether or not the plurality of people 4 are in close contact with each other. Note that the other configurations are similar to those in the estimation system 1 according to the embodiment described above, the same components are denoted by the same reference signs as those in the embodiment, and the description thereof is omitted.

The first estimator 12 estimates, based on the thermal image 200 including the plurality of heat sources 6, the body temperatures of the plurality of people 4. Here, the thermal image 200 includes temperature information as described above. Thus, the first estimator 12 can estimate the body temperatures of the plurality of people 4 from the thermal image 200. In this case, a first distance is preferably greater than a second distance. The first distance is a distance between a person 4 to a person 4 as a basis for estimation that the plurality of people 4 are in close contact with each other by the second estimator 13 when at least one of the plurality of body temperatures corresponding to the respective plurality of people 4 is higher than or equal to a predetermined temperature. The second distance is a distance between a person 4 and a person 4 as a basis for estimation that the plurality of people 4 are in close contact with each other by the second estimator 13 when each of all the plurality of body temperatures corresponding to the respective plurality of people 4 is lower than the predetermined temperature. In this case, if a person 4 having a body temperature of higher than or equal to the predetermined temperature is included in the plurality of people 4, the second estimator 13 estimates that the plurality of people 4 are in close contact with each other when the distance L1 is less than or equal to the first distance, even in the case of the distance L1 between the heads 5 of the plurality of people 4 being greater than or equal to the second distance. Here, the predetermined temperature is, for example, 37.5 degrees Celsius, but the predetermined temperature may be higher than, or lower than, 37.5 degrees Celsius.

The estimation system 1 according to the third variation has an improved estimation accuracy of estimation as to whether or not the plurality of people 4 are in close contact with each other as compared with the case where the body temperatures of the plurality of people 4 are not taken into consideration.

### (5.4) Fourth Variation

An estimation system 1 according to a fourth variation will be described with reference to FIG. 2.

The estimation system 1 according to the fourth variation is different from the estimation system 1 according to the embodiment described above in that a wall 102 facing the target space (the internal space of the building) 100 is included in a detection region of the infrared sensor 2. Note that the other configurations are similar to those in the estimation system 1 according to the embodiment described above, the same components are denoted by the same reference signs as those in the embodiment, and the description thereof is omitted.

For example, as shown in FIG. 2, the wall 102 facing the target space 100 is assumed to have a window 103. In this case, in a state where the window 103 is closed, a heat distribution of a region of the wall 102 including the window 103 is uniform. In contrast, in a state where the window 103 is open, the target space 100 is ventilated, and therefore, a heat distribution of a region corresponding to the window 103 is different from the heat distribution of the region of the wall 102 except for the region corresponding to the window 103. More specifically, for example, when an outdoor temperature is higher than a room temperature, the temperature of the region corresponding to the window 103 is higher than the temperature of the region of the wall 102 except for the region corresponding to the window 103. Moreover, for example, when the outdoor temperature is lower than the room temperature, the temperature of the region corresponding to the window 103 is lower than the temperature of the region of the wall 102 except for the region corresponding to the window 103.

Thus, the first estimator 12 can estimate that the target space 100 is in a ventilated state when the heat distribution of the region corresponding to the window 103 of the region of the wall 102 is different from the heat distribution of the region of the wall 102 except for the region corresponding to the window 103. That is, the first estimator 12 estimates that the target space 100 is in the ventilated state when the region estimated to be the wall 102 facing the target space 100 in the heat distribution including the plurality of heat sources 6 includes a portion (e.g., the region corresponding to the window 103) having a different heat distribution from another portion in the region estimated to be the wall 102. In this case, a third distance is preferably less than a fourth distance. The third distance is a distance between a person 4 and a person 4 as a basis for estimation that the plurality of people 4 are in close contact with each other by the second estimator 13 when the target space 100 is estimated to be in the ventilated state. The fourth distance is a distance between a person 4 and a person 4 as a basis for estimation that the plurality of people 4 are in close contact with each other by the second estimator 13 when the target space 100 is estimated to be out of the ventilated state. In this case, when the target space 100 is estimated to be in the ventilated state, the second estimator 13 estimates that the plurality of people 4 are not in close contact with each other even in the case of the distance L1 between the heads 5 of the plurality of people 4 being the third distance less than the fourth distance.

The estimation system 1 according to the fourth variation has an improved estimation accuracy of estimation as to whether or not the plurality of people 4 are in close contact with each other as compared with the case where whether or not the target space 100 is in the ventilated state is not taken into consideration.

### (5.5) Fifth Variation

An estimation system 1 according to a fifth variation will be described.

The estimation system 1 according to the fifth variation is different from the estimation system 1 according to the embodiment described above in that the second estimator 13 can further estimate the degree of crowdedness of the target space 100. Note that the other configurations are similar to those in the estimation system 1 according to the embodiment described above, the same components are denoted by the same reference signs as those in the embodiment, and the description thereof is omitted.

In the estimation system 1 according to the fifth variation, the second estimator 13 can estimate also the degree of crowdedness of the target space 100. More specifically, the second estimator 13 can estimate the degree of crowdedness of the target space 100, for example, from the ratio (proportion) of the sum of volumes of the plurality of people 4 to the volume of the target space 100. When the degree of crowdedness of the target space 100 exceeds a specified value, the output 14 outputs (transmits), for example, a notice that the target space 100 is crowded to the plurality of external apparatuses 3 carried by the respective plurality of people 4. This can notify the plurality of people 4 of (can transmit, to the plurality of people 4, a notice) that the target space 100 is crowded.

### (5.6) Sixth Variation

An estimation system 1 according to a sixth variation will be described.

In the estimation system 1 according to the sixth variation, the output 14 includes a lamp disposed, for example, in the housing 110 (see FIG. 2) of the human monitoring system 10. The output 14 turns off the lamp when the plurality of people 4 are not in close contact with each other, whereas the output 14 turns on the lamp when the plurality of people 4 are in close contact with each other. This can notify the plurality of people 4 present in the target space 100 of whether or not the plurality of people 4 are in close contact with each other.

Moreover, the output 14 may be configured to output a voice message saying that the window 103 should be opened. For example, when the plurality of people 4 are in close contact with each other in the target space 100, a voice message saying that the window 103 should be opened is output to the plurality of people 4 present in the target space 100, thereby prompting the plurality of people 4 to open the window 103.

Moreover, when the window 103 has an automatically opened/closed structure, the output 14 may be configured to output an open/close signal to the window 103. For example, when the plurality of people 4 are in close contact with each other in the target space 100, the output 14 outputs, to the window 103, an open signal for opening the window 103. Thus, when the plurality of people 4 are in close contact with each other in the target space 100, automatically opening the window 103 enables the target space 100 to be ventilated. Note that when the plurality of people 4 are not in close contact with each other in the target space 100, the output 14 may output, but does not have to output, an open signal for opening the window 103 or a close signal for closing the window 103.

Moreover, the output 14 is not limited to the configuration described above but may be, for example, a display or a printer. When the output 14 is a display, the output 14 displays the estimation result by the second estimator 13, thereby giving a notice the plurality of people 4 are in close contact with each other in the target space 100. Moreover, when the output 14 is a printer, the output 14 prints the estimation result by the second estimator 13, thereby giving a notice that the plurality of people 4 are in close contact with each other in the target space 100.

### (5.7) Other Variations

The estimation system 1 of the present disclosure includes a computer system. The computer system may include a processor and a memory element as principal hardware components thereof. The functions of the estimation system 1 according to the present disclosure may be implemented by making the processor execute a program stored in the memory element of the computer system. The program may be stored in advance in the memory of the computer system. Alternatively, the program may also be downloaded through a telecommunications network or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memory elements. Thus, the microcontroller may also be implemented as a single or a plurality of electronic circuits including a semiconductor integrated circuit or a large-scale integrated circuit.

Also, in the embodiment described above, the plurality of functions of the estimation system 1 are aggregated together in a single housing 110 (see FIG. 2). However, this is not an essential configuration for the estimation system 1. Alternatively, these constituent elements of the estimation system 1 may be distributed in multiple different housings. Still alternatively, at least some functions of the estimation system 1 may be implemented as, for example, a server device and a cloud computing system. Conversely, all functions of the estimation system 1 may be aggregated together in a single housing 110 as in the embodiment described above.

In the embodiment described above, the human monitoring system 10 includes one infrared sensor 2, but the human monitoring system 10 may include a plurality of infrared sensors 2. In this case, all the plurality of infrared sensors 2 are preferably disposed on the ceiling 101 facing the target space (the internal space of the building) 100. Then, the plurality of infrared sensors 2 are preferably disposed at different locations on the ceiling 101 such that detection regions of the plurality of infrared sensors 2 partially overlap each other. Thus, a blind angle of the infrared sensors 2 can be reduced, and as compared with the case where the one infrared sensor 2 is disposed on the ceiling 101, the detection accuracy of each person 4 can be improved.

Moreover, at least one of the plurality of infrared sensors 2 may be disposed on the ceiling 101 facing the target space (the internal space of the building) 100, and at least one of the plurality of infrared sensors 2 may be disposed on the wall 102 facing the target space 100. In other words, the plurality of infrared sensors 2 include an infrared sensor 2 disposed on the ceiling 101 facing the target space 100 and an infrared sensor 2 installed on the wall 102 facing the target space 100. Also in this case, the plurality of infrared sensors 2 are preferably disposed on the ceiling 101 and the wall 102 such that the detection regions of the plurality of infrared sensors 2 partially overlap each other. Thus, the blind angle of the infrared sensors 2 can be reduced, and as compared with the case where the one infrared sensor 2 is disposed on the ceiling 101, the detection accuracy of each person 4 can be improved.

In the embodiment described above, the first estimator 12 and the second estimator 13 are separately disposed from each other, but the first estimator 12 and the second estimator 13 may be formed as one estimator.

In the embodiment described above, the target space 100 is the internal space of the building, but the target space 100 may be, for example, an internal space of a moving vehicle. Examples of the moving vehicle include railway trains, buses, automobiles, aircraft, and watercraft.

In the embodiment described above, the infrared sensor 2 is a passive sensor, but the infrared sensor 2 is not limited to the passive sensor but may be an active sensor. In this case, the infrared sensor 2 emits an infrared ray to an object (e.g., a person 4) and receives light reflected off the object, thereby detecting the object.

### (Aspects)

The present specification discloses the following aspects.

An estimation system (1) of a first aspect includes a first estimator (12) and a second estimator (13). The first estimator (12) is configured to estimate, based on a heat distribution (200) including a plurality of heat source (6) detected by at least one infrared sensor (2), three-dimensional positions of heads (5) of plurality of people (4) in a target space (100). The second estimator (13) is configured to estimate, based on data on the three-dimensional positions estimated by the first estimator (12), whether or not the plurality of people (4) are in close contact with each other.

With this aspect, whether or not the plurality of people (4) are in close contact with each other in the target space (100) is accurately estimated.

An estimation system (1) of a second aspect referring to the first aspect further includes an output (14). The output (14) is configured to output an estimation result by the second estimator (13).

With this aspect, the estimation result by the second estimator (13) is output.

In an estimation system (1) of a third aspect referring to the first or second aspects, the second estimator (13) is configured to, when a residence time of each of the plurality of heat sources (6) in the target space (100) is shorter than a predetermined time, determine that the plurality of people (4) are out of close contact with each other. The second estimator (13) is configured to, when the residence time is longer than or equal to the predetermined time, estimate, based on the data on the three-dimensional positions, that the plurality of people (4) are in close contact with each other.

With this aspect, the residence time of each of the plurality of people (4) in the target space (100) is taken into consideration, thereby improving the estimation accuracy of estimation as to whether or not the plurality of people (4) are in close contact with each other.

In an estimation system (1) of a fourth aspect referring to any one of the first to third aspects, the first estimator (12) is configured to estimate, based on trajectories of movements of the plurality of heat sources (6), moving directions of the plurality of people (4) in addition to the three-dimensional positions. The second estimator (13) is configured to estimate orientations of the heads (5) of the plurality of people (4) from the moving directions of the plurality of people (4) and estimate, based on the data on the three-dimensional positions and the orientations of the heads (5) of the plurality of people (4), whether or not the plurality of people (4) are in close contact with each other.

With this aspect, the orientations of the heads (5) of the plurality of people (4) are taken into consideration, thereby improving the estimation accuracy of estimation as to whether or not the plurality of people (4) are in close contact with each other.

In an estimation system (1) of a fifth aspect referring to any one of the first to fourth aspects, the first estimator (12) is configured to estimate, based on the heat distribution (200) including the plurality of heat sources (6), body temperatures of the plurality of people (4). The second estimator (13) is configured to estimate, based on a first distance between a person (4) and a person (4), that the plurality of people (4) are in close contact with each other when at least one of the body temperatures of the plurality of people (4) is higher than or equal to a predetermined temperature. The second estimator (13) is configured to estimate, based on a second distance between the person (4) and the person (4), that the plurality of people (4) are in close contact with each other when each of all the body temperatures of the plurality of people (4) is lower than the predetermined temperature. The first distance is greater than the second distance.

With this aspect, the body temperatures of the plurality of people (4) are taken into consideration, thereby improving the estimation accuracy of estimation as to whether or not the plurality of people (4) are in close contact with each other.

In an estimation system (1) of a sixth aspect referring to any one of the first to fifth aspects, the target space (100) is an internal space (100) of a building or a moving vehicle. The first estimator (12) is configured to estimate that the internal space (100) is in a ventilated state when a region estimated to be a wall (102) facing the internal space (100) in the heat distribution (200) including the plurality of heat sources (6) includes a portion (a window 103) having a different heat distribution from another portion in the region estimated to be the wall (102). The second estimator (13) is configured to estimate, based on a third distance between a person (4) and a person (4), that the plurality of people (4) are in close contact with each other when the internal space (100) is estimated to be in the ventilated state. The second estimator (13) is configured to estimate, based on a fourth distance between the person (4) and the person (4), that the plurality of people (4) are in close contact with each other when the internal space (100) is estimated to be out of the ventilated state. The third distance is less than the fourth distance.

With this aspect, the ventilation state of the target space (100) is taken into consideration, thereby improving the estimation accuracy of estimation as to whether or not the plurality of people (4) are in close contact with each other.

A human monitoring system (10) of a seventh aspect includes: the estimation system (1) of any one of the first to sixth aspects; and the at least one infrared sensor (2).

With this aspect, whether or not the plurality of people (4) are in close contact with each other in the target space (100) is accurately estimated.

A human monitoring system (10) of an eighth aspect referring to the seventh aspect, the at least one infrared sensor (2) includes a plurality of infrared sensors (2). the target space (100) is an internal space (100) of a building or a moving vehicle. The plurality of infrared sensors (2) are disposed at different locations on the ceiling (101) facing the internal space (100).

With this aspect, the detection accuracy of the person (4) can be improved as compared to the case where the one infrared sensor (2) is disposed on the ceiling (101).

A human monitoring system (10) according to a ninth aspect referring to the seventh aspect, the at least one infrared sensor (2) includes a plurality of infrared sensors (2). The target space (100) is an internal space (100) of a building or a moving vehicle. The plurality of infrared sensor (2) includes an infrared sensor (2) disposed on a ceiling (101) facing the internal space (100) and an infrared sensor (2) disposed on the wall (102) facing the internal space (100).

With this aspect, the detection accuracy of the person (4) can be improved as compared with the case where the one infrared sensor (2) is disposed on the ceiling (101).

An estimation method of a tenth aspect includes a first estimation step (ST3) and a second estimation step (ST4). The first estimation step (ST3) is a step of estimating, based on a heat distribution (200) including a plurality of heat sources (6) detected by an infrared sensor (2), three-dimensional positions of heads (5) of a plurality of people (4) in a target space (100). The second estimation step (ST4) is a step of estimating, based on data on the three-dimensional positions estimated in the first estimation step (ST3), whether or not the plurality of people (4) are in close contact with each other.

With this aspect, whether or not the plurality of people (4) are in close contact with each other in the target space (100) is accurately estimated

A program of an eleventh aspect is a program configured to cause one or more processors to execute the estimation method of the tenth aspect.

With this aspect, whether or not the plurality of people (4) are in close contact with each other in the target space (100) is accurately estimated

The configurations according to the second to sixth aspects are not essential configurations for the estimation system (1) and may accordingly be omitted.

The configurations of the eighth and ninth aspects are not essential configurations for the human monitoring system (10) and may accordingly be omitted.

### REFERENCE SIGNS LIST

1 Estimation System
2 Infrared Sensor
4, 41, 42 Person
5, 51, 52 Head
6, 61, 62 Heat Source
10 Human Monitoring System
12 First Estimator
13 Second Estimator
14 Output
100 Target Space
200 Thermal Image (Heat Distribution)
ST3 First Estimation Step
ST4 Second Estimation Step

1. An estimation system comprising:
a first estimator configured to estimate, based on a heat distribution including a plurality of heat sources detected by at least one infrared sensor, three-dimensional positions of heads of a plurality of people in a target space; and
a second estimator configured to estimate, based on data on the three-dimensional positions estimated by the first estimator, whether or not the plurality of people are in close contact with each other.

2. The estimation system of claim 1, further comprising
an output configured to output an estimation result by the second estimator.

3. The estimation system of claim 1 or 2, wherein
the second estimator is configured to
when a residence time of each of the plurality of heat sources in the target space is shorter than a predetermined time, determine that the plurality of people are out of close contact with each other and
when the residence time is longer than or equal to the predetermined time, estimate, based on the data on the three-dimensional positions, that the plurality of people are in close contact with each other.

4. The estimation system of any one of claims 1 to 3, wherein
the first estimator is configured to estimate, based on trajectories of movements of the plurality of heat sources, moving directions of the plurality of people in addition to the three-dimensional positions, and
the second estimator is configured to
estimate orientations of the heads of the plurality of people from the moving directions of the plurality of people and
estimate, based on the data on the three-dimensional positions and the orientations of the heads of the plurality of people, whether or not the plurality of people are in close contact with each other.

5. The estimation system of any one of claims 1 to 4, wherein
the first estimator is configured to estimate, based on the heat distribution including the plurality of heat sources, body temperatures of the plurality of people,
the second estimator is configured to:
estimate, based on a first distance between the plurality of people, that the plurality of people are in close contact with each other when at least one of the body temperatures of the plurality of people is higher than or equal to a predetermined temperature; and
estimate, based on a second distance between the plurality of people, that the plurality of people are in close contact with each other when each of all the body temperatures of the plurality of people is lower than the predetermined temperature, and
the first distance is greater than the second distance.

6. The estimation system of any one of claims 1 to 5, wherein
the target space is an internal space of a building or a moving vehicle,
the first estimator is configured to estimate that the internal space is in a ventilated state when a region estimated to be a wall facing the internal space in the heat distribution including the plurality of heat sources includes a portion having a different heat distribution from another portion in the region estimated to be the wall,
the second estimator is configured to:
estimate, based on a third distance between the plurality of people, that the plurality of people are in close contact with each other when the internal space is estimated to be in the ventilated state; and
estimate, based on a fourth distance between the plurality of people, that the plurality of people are in close contact with each other when the internal space is estimated to be out of the ventilated state, and
the third distance is less than the fourth distance.

7. A human monitoring system comprising:
the estimation system of any one of claims 1 to 6; and
the at least one infrared sensor.

8. The human monitoring system of claim 7, wherein
the at least one infrared sensor includes a plurality of infrared sensors,
the target space is an internal space of a building or a moving vehicle, and
the plurality of infrared sensors are disposed at different locations on a ceiling facing the internal space.

9. The human monitoring system of claim 7, wherein
the at least one infrared sensor includes a plurality of infrared sensors,
the target space is an internal space of a building or a moving vehicle, and
the plurality of infrared sensors include
an infrared sensor disposed on a ceiling facing the internal space and
an infrared sensor disposed on the wall facing the internal space.

10. An estimation method comprising:
a first estimation step of estimating, based on a heat distribution including a plurality of heat sources detected by an infrared sensor, three-dimensional positions of heads of a plurality of people in a target space; and
a second estimation step of estimating, based on data on the three-dimensional positions estimated in the first estimation step, whether or not the plurality of people are in close contact with each other.

11. A program configured to cause one or more processors to execute the estimation method of claim 10.
